(19) United States
(12) Patent Application Publication
(10) Pub. No.: US 2026/0192578 A1
(43) Pub. Date: Jul. 9, 2026

(54) PAPER FEEDING DEVICE, PAPER FEEDING METHOD AND COMPUTER-READABLE RECORDING MEDIUM

(71) Applicant: CANON KABUSHIKI KAISHA, Tokyo (JP)

(72) Inventor: YUTO NINOMIYA, Kanagawa (JP)

(21) Appl. No.: 19/440,415

(22) Filed: Jan. 5, 2026

(30) Foreign Application Priority Data
Jan. 7, 2025 (JP) 2025-002172

(51) Int. Cl. B41J 11/00; B41J 15/04

(52) U.S. Cl. CPC B41J 11/0095; B41J 15/048

(57) ABSTRACT

A paper feeding device includes: a roll holder configured to fix a roll of recording medium; an attachment configured to be removably attached to the roll holder and capable of adjusting a clearance between a roll core of the roll of recording medium and the roll holder; a motor configured to rotate the roll of recording medium with the roll holder; a circumference detection unit configured to detect an amount of conveyance of a circumference of the roll of recording medium; and a notification unit configured to notify information relating to the attachment based on an obtaining result from the rotation obtaining unit and based on a detection result from the circumference detection unit.

### BACKGROUND

### Field of the Technology

The present disclosure relates to attachment of roll paper.

### Description of the Related Art

Conventionally, feeding of roll paper is controlled by detecting the roll paper. U.S. Patent Application Publication No. 2022/0297968 (referred to as Literature 1, hereinafter) discloses a technique of automatically conveying a sheet of roll paper by detecting a front edge of the sheet.

There are various types of roll paper, and roll cores of different types of roll paper may have different inner diameters. Therefore, roll paper can be properly rotated by using an attachment fitting to the inner diameter of the roll core of the roll paper.

However, according to the technique disclosed in Literature 1, even when an attachment that does not fit to the inner diameter of the roll core of the roll paper, it is disclosed that control is performed to feed a sheet of the roll paper to the position where printing can be done in Literature 1. Therefore, the roll paper may not be rotated properly and the roll paper continues to rotate improperly, which may result in the case of the paper not being able to be fed or may result in the case where a jam occur.

### SUMMARY

A paper feeding device according to an aspect of the present disclosure includes: a roll holder configured to fix a roll of recording medium; an attachment configured to be removably attached to the roll holder and capable of adjusting a clearance between a roll core of the roll of recording medium and the roll holder; a motor configured to rotate the roll of recording medium with the roll holder; a rotation obtaining unit configured to obtain a rotational angle of a rotational axis of the roll recording medium; a circumference detection unit configured to detect an amount of conveyance of a circumference of the roll of recording medium; and a notification unit configured to notify information relating to the attachment based on an obtaining result from the rotation obtaining unit and based on a detection result from the circumference detection unit.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of a recording device;

FIG. 2 is a block diagram illustrating a control system in a recording system including the recording device;

FIG. 3 is a schematic cross-sectional view of the recording device;

FIG. 4 is an exploded perspective view of a roll unit;

FIG. 5 is a flowchart illustrating an automatic paper feeding process;

FIG. 6 is a flowchart illustrating a process of detecting an error of an attachment according to a first embodiment;

FIG. 7A is a schematic diagram showing a case where the number of edges of a detected waveform required until a circumference detecting mechanism is stopped after a rotation detecting mechanism is stopped is less than two according to the first embodiment;

FIG. 7B is a diagram showing a case where the number of edges of the detected waveform required until the circumference detecting mechanism is stopped after the rotation detecting mechanism is stopped is not less than two according to the first embodiment;

FIG. 8A is a diagram showing an example in which the possibility that attachments have wrong sizes is indicated;

FIG. 8B is a diagram showing an example in which replacing the attachments with other attachments is recommended;

FIG. 8C is a diagram showing another example in which replacing the attachments with other attachments is recommended;

FIG. 9 is a flowchart illustrating a process of detecting an error of an attachments according to a second embodiment;

FIG. 10 is a schematic diagram showing essential parts in the second embodiment;

FIG. 11A is a diagram showing a case where a detection period of the circumference detecting mechanism is stable during rotation of the rotation detecting mechanism according to the second embodiment;

FIG. 11B is a diagram showing a case where the detection period of the circumference detecting mechanism is not stable during rotation of the rotation detecting mechanism according to the second embodiment;

FIG. 12 is a flowchart illustrating a process of detecting an error of an attachment according to a third embodiment;

FIG. 13A is a diagram showing a case where the detection period of the circumference detecting mechanism is stable during rotation of the rotation detecting mechanism according to the third embodiment; and

FIG. 13B is a diagram showing a case where the detection period of the circumference detecting mechanism is not stable during rotation of the rotation detecting mechanism according to the third embodiment.

### DESCRIPTION OF THE EMBODIMENTS

In the following, preferred embodiments of the present disclosure will be described in detail with reference to the accompanying drawings. Note that the embodiments described below are not intended to limit the present disclosure, and all combinations of features described in the embodiments below are not essential for the solution of the present disclosure. The same components are denoted by the same reference numerals.

### Overview

A recording device that automatically feed a sheet of attached roll paper by detecting a front edge of the sheet is disclosed. With the recording device, a sensor detects the front edge of a sheet of roll paper while the roll paper is rotating in a winding direction opposite to the supply direction of the roll paper. With the recording device, furthermore, when the detection of the front edge of the sheet is completed, the sheet is peeled and separated from the roll paper while rotating the roll paper in the supply direction, and the separated sheet is fed through a medium path to a position where printing can be done.

There are many types of recording medium used in recording devices. In case where the recording medium is roll paper, different types of recording medium have different inner diameters of the roll core of the roll paper. In general, roll paper that is more likely to have a curling habit is wrapped around a roll core of a larger inner diameter. In contrast, roll paper that is less likely to have a curling habit is wrapped around a roll core of a smaller inner diameter. Such roll paper is set in the recording device in a state where the roll paper is held by a spool and a holder. For the spool and the holder, an attachment fitting to the inner diameter of the roll core is prepared. Typically, using an attachment fitting to the inner diameter of the roll core allows desired roll paper to be set in the recording device and to be used as a recording medium. Therefore, in order to feed a sheet of roll paper in a state where a certain tension is applied to the sheet, the user needs to select and attach an attachment fitting to the inner diameter of the roll core of the roll paper.

However, even when an attachment that does not fit to the roll core of the roll paper is used, there is no capability to detect that the attachment that does not fit to the roll core of the roll paper is used. Therefore, there is a case where the cause of feeding error of the sheet of the roll paper and countermeasures of the feeding error are not indicated to the user. For example, even when roll paper set in the recording device is automatically fed to the position where printing can be done by an automatic paper feeding mechanism, it is not detected that an attachment that does not fit to the roll core of the roll paper is used. Therefore, the cause of the feeding error and countermeasures of the feeding error cannot be indicated to the user. Furthermore, when the attachment is not compatible with the roll core of the roll paper, specifically, in case where a smaller attachment than the roll core of the roll paper is attached, the roll paper does not rotate properly. Therefore, there is a possibility in that the paper is not able to be fed or in that a jam occur.

In view of such circumstances, according to the present disclosure, information relating to an attachment is notified based on a detection result of the rotational angle of an axis of a roll of recording medium such as roll paper and a detection result of the amount of conveyance of the circumference of the roll of recording medium. With this configuration, whether the attachment does not fit to the roll core of the roll paper can be notified, so that a difficulty in continuing paper feeding or occurrence of a jam can be prevented.

### First Embodiment

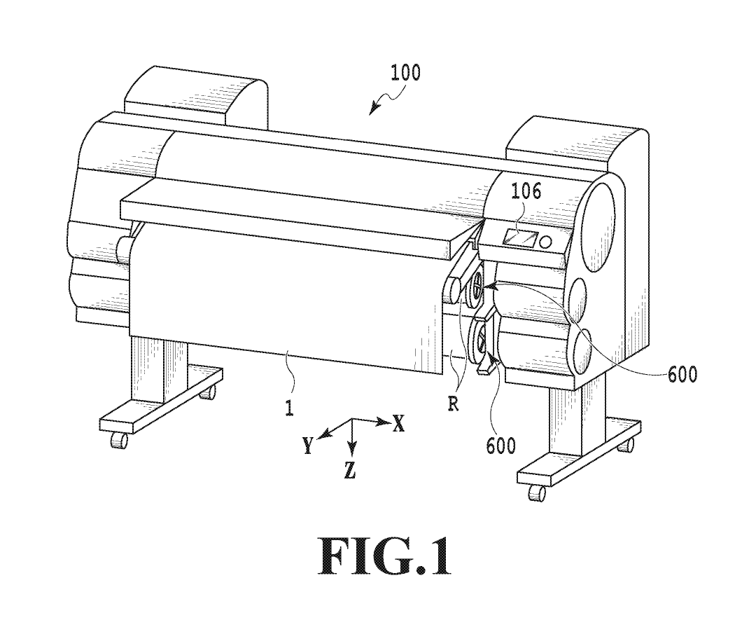

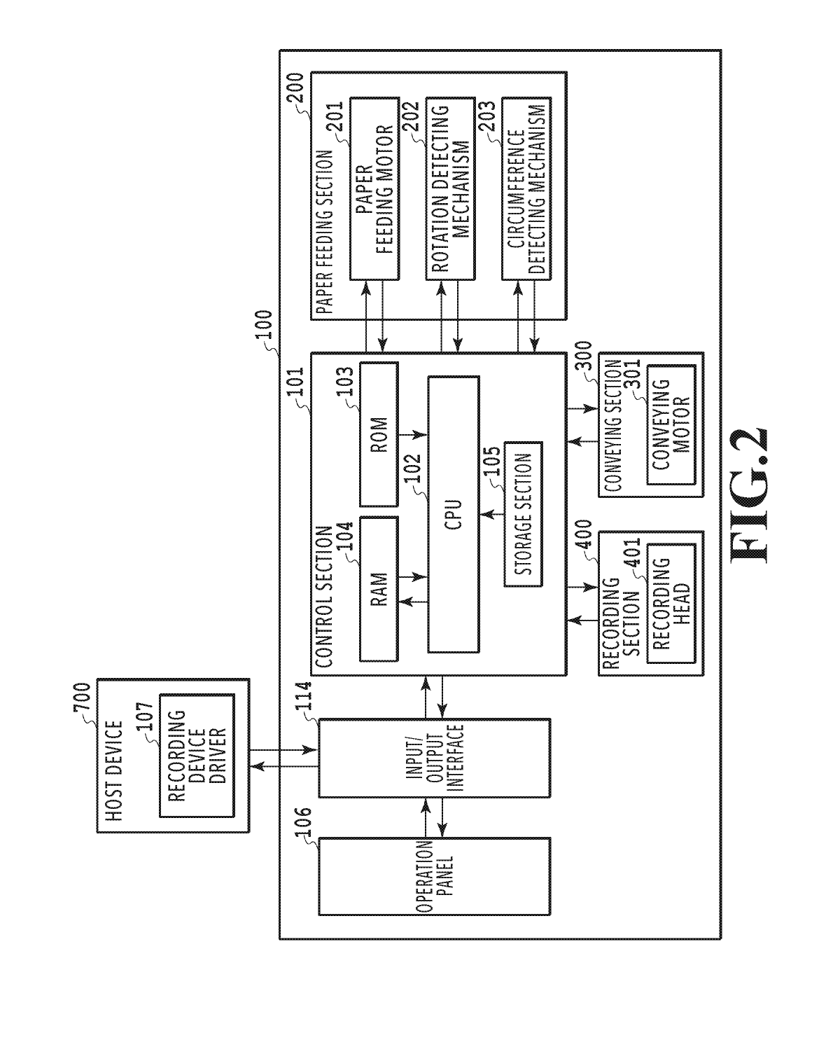

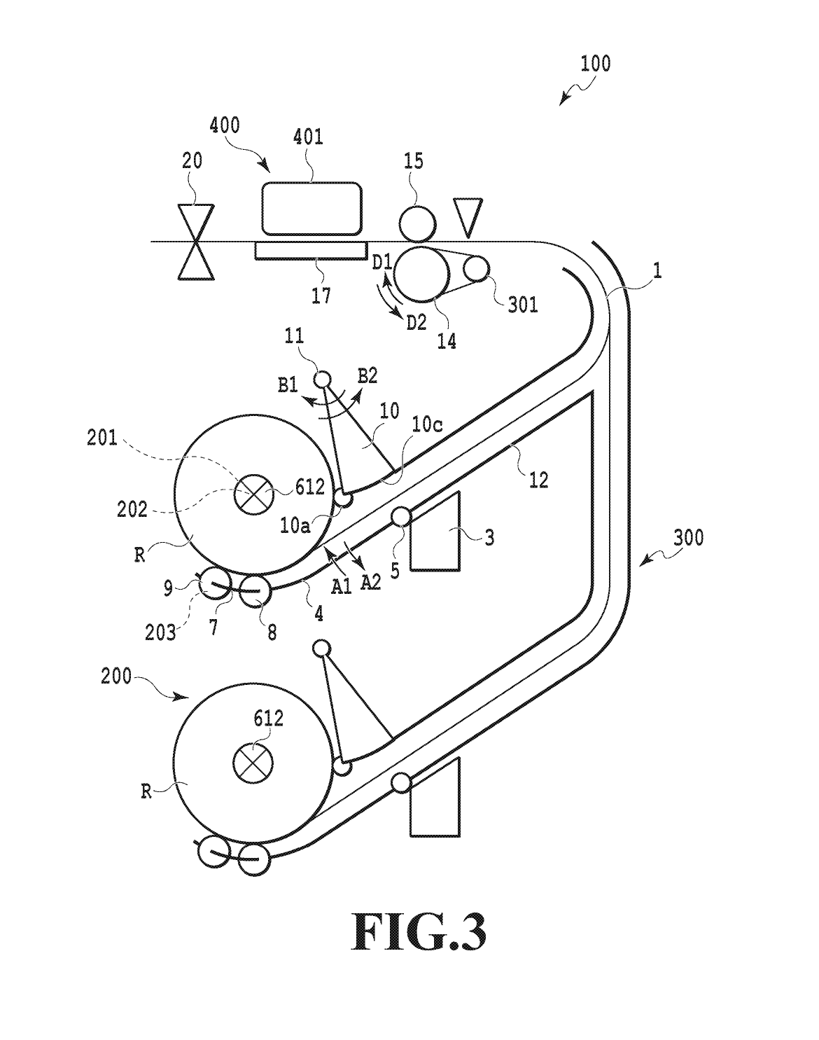

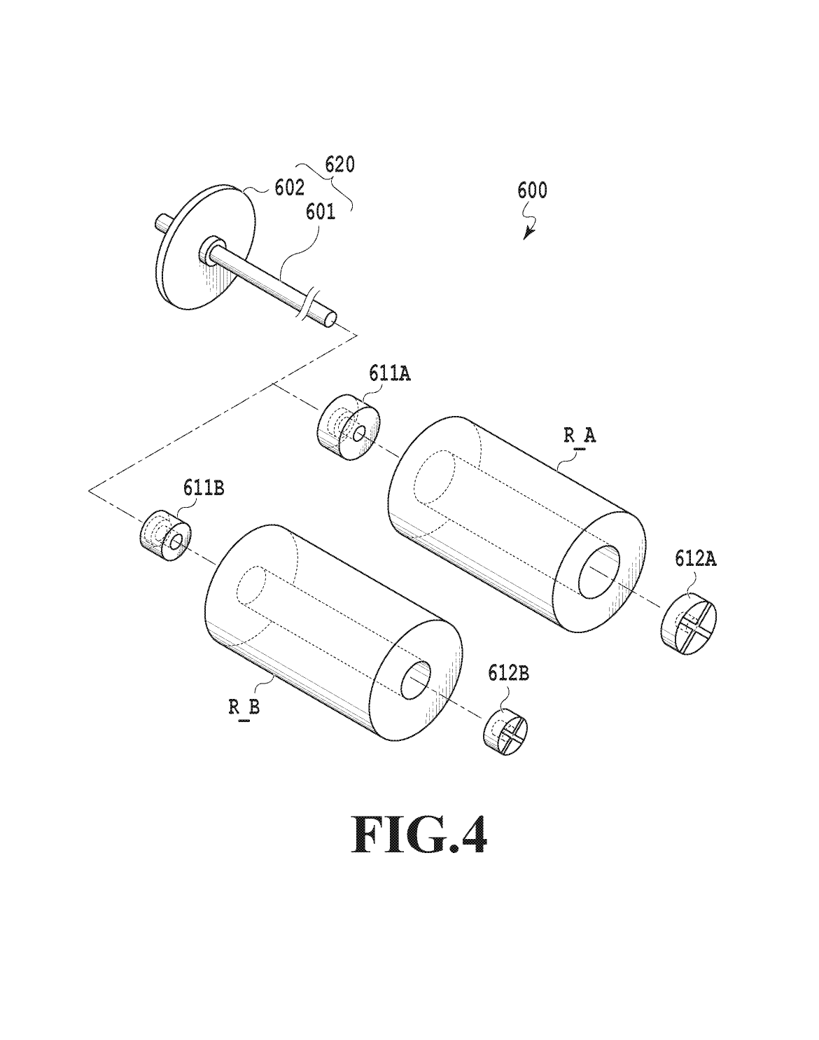

In the following, an application of the present disclosure will be described with reference to the drawings. FIG. 1 is a perspective view of a recording device 100. FIG. 2 is a block diagram illustrating a control system in a recording system including the recording device 100. FIG. 3 is a schematic cross-sectional view of the recording device 100. FIG. 4 is an exploded perspective view of a roll unit 600. In FIG. 1, an X direction, a Y direction and a Z direction are defined. The X direction and the Y direction are perpendicular to each other. The Z direction is perpendicular to an X-Y plane. In the application of the present disclosure, the Z direction is the vertical direction. The recording device 100 according to the application of the present disclosure includes a paper feeding section 200 as a paper feeding device and a recording section 400 as a recording device, as described later with reference to FIGS. 2 and 3. The paper feeding section 200 supplies a sheet 1 that is a rolled recording medium to the recording section 400. The recording section 400 records an image on the sheet 1 supplied by the paper feeding section 200.

As shown in FIG. 1, the recording device 100 can house roll paper R. The roll paper R is formed as a recording medium by rolling the sheet 1, which is an elongated continuous sheet. In the example in FIG. 1, roll units 600 each containing roll paper R are housed at upper and lower positions. There are various types of roll paper R, and the inner diameter of the roll paper R may vary with the type. As shown in FIG. 1, the recording device 100 is provided with an operation panel 106. Specification of the type of the recording medium or information relating to the recording device 100 can be input by a user operating the operation panel 106. Note that the operation panel 106 is formed by a touch-sensitive display including a touch panel on a liquid crystal display, for example.

As shown in FIG. 2, the recording system includes the recording device 100 and a host device 700. The recording device 100 includes a control section 101, the paper feeding section 200, a conveying section 300, the recording section 400, an input/output interface 114 and the operation panel 106 described above. The control section 101 includes a CPU 102, a ROM 103, a RAM 104 and a storage section 105.

The CPU 102 is a processing unit for implementing various functions of the recording device 100. The CPU 102 includes at least one processor. The CPU 102 performs various types of processing through execution of a program or activation of hardware. The execution of a program is achieved by deploying the program in the RAM 104. The various types of processing by the CPU 102 include control of the paper feeding section 200, the conveying section 300 and the recording section 400.

The ROM 103 stores various types of data. For example, the ROM 103 stores a program for the CPU 102 to perform processing. Such programs include a device driver and the like. Furthermore, the ROM 103 stores data required for operation of the recording device 100.

The RAM 104 is used as a work area for the CPU 102. That is, the RAM 104 stores data required for execution of processing by the CPU 102. The data includes programs. The RAM 104 can be used as a temporary storage region for data.

The storage section 105 is a storage device, such as a hard disk drive device. The storage section 105 stores various types of driver software and various types of application software, for example.

The control section 101 is connected to the input/output interface 114. The input/output interface 114 can transmit various types of information between the control section 101 and the operation panel 106. For example, the input/output interface 114 transmits medium type information indicating the type of the recording medium and various types of setting information from the operation panel 106 to the control section 101. Furthermore, the input/output interface 114 can transmit various types of information between the control section 101 and the host device 700. For example, the input/output interface 114 transmits recording data that allows the recording section 400 to record an image on the sheet 1 from the host device 700 to the control section 101.

The host device 700 is an information processing device capable of processing various types of information. The host device 700 is disposed outside of the recording device 100. The host device 700 includes a recording device driver 107. The recording device driver 107 can exchange various types of information with the recording device 100. The recording device driver 107 can make the recording device 100 record an image on a recording medium. For example, the recording device driver 107 generates recording data that allows the recording section 400 to record an image on the sheet 1, and supplies the recording data to the recording device 100 via the input/output interface 114. Note that the host device 700 may be implemented by a personal computer functioning as an information processing device. Alternatively, the host device 700 may be implemented by an external server functioning as an information processing device. Alternatively, the host device 700 may be implemented as a cloud service.

The control section 101 controls the paper feeding section 200. The paper feeding section 200 includes a paper feeding motor 201, a rotation detecting mechanism 202 and a circumference detecting mechanism 203. Details of functions of the paper feeding section 200 will be described later with reference to FIGS. 3 and 4. The control section 101 controls the conveying section 300. The conveying section 300 includes a conveying motor 301. Details of functions of the conveying section 300 will be described later with reference to FIG. 3. The control section 101 controls the recording section 400. The recording section 400 includes a recording head 401. Details of functions of the recording section 400 will be described later with reference to FIG. 3.

In the example in FIG. 3, roll paper R is set at two positions, an upper position and a lower position. Furthermore, as shown in FIG. 3, in the recording device 100, the paper feeding section 200, the conveying section 300 and the recording section 400 are provided. The paper feeding section 200 is provided for each housing space for the roll paper R. In the example in FIG. 3, two paper feeding sections 200 corresponding to two pieces of roll paper R are provided. The paper feeding section 200 feeds the sheet 1 from the roll paper R to the conveying section 300. The conveying section 300 has a conveying guide 12. The conveying guide 12 guides the sheet 1 drawn from the paper feeding section 200 to the recording section at the front and back surfaces of the sheet 1. That is, the conveying section 300 conveys the roll paper R to the recording section 400 along the conveying guide 12. The recording section 400 records an image on the sheet 1 conveyed by the conveying section 300.

Next, details of the paper feeding section 200 will be described with reference to FIGS. 3 and 4. Each of roll paper R_A and R_B housed in the paper feeding section 200 has a roll core. Each of the roll paper R_A and R_B is formed by wrapping the sheet 1 in FIG. 1 on the roll core. The shape of each roll core is a hollow shape.

The roll paper R_A is fixed to a roll holder 620 via attachments 611A and 612A. The shape of the attachments 611A and 612A is a cylindrical shape. Furthermore, the roll holder 620 has a spool member 601 and a flange 602. The shape of the spool member 601 is a cylindrical shape. The shape of the flange 602 is a disc shape. A through-hole is formed at a central part of the flange 602. One end part of the spool member 601 is inserted in the through-hole of the flange 602. Another end part of the spool member 601 is fixed to the roll paper R_A via the attachments 611A and 612A. Specifically, the attachment 612A is fixed to the other end part of the spool member 601 at a position close to the tip end thereof, thereby adjusting the clearance between the roll paper R_A and the roll holder 620. The attachment 611A is fixed to the flange 602 in a state where the flange 602 and an end face of the roll paper R_A are in contact with each other, thereby adjusting the clearance from the roll core of the roll paper R_A. The inner diameter of the roll core, which corresponds to the inner diameter of the roll paper R_A, and the outer diameter of the attachments 611A and 612A are approximately equal to each other, and the attachments 611A and 612A are sized to be able to be inserted into the roll core of the roll paper R_A. With this configuration, the attachments 611A and 612A can adjust the clearance between the roll core of the roll paper R_A and the roll holder 620. In addition, each of the attachments 611A and 612A can be removably attached to the roll holder 620.

The inner diameter of the roll core of the roll paper R_B is smaller than the inner diameter of the roll core of the roll paper R_A. Therefore, the roll paper R_B is formed by paper that is less likely to have a curling habit than the roll paper R_A. The roll paper R_B is fixed to the roll holder 620 via attachments 611B and 612B. One end part of the spool member 601 is inserted in the through-hole of the flange 602. Another end part of the spool member 601 is fixed to the roll paper R_B via the attachments 611B and 612B. Specifically, the attachment 612B is fixed to the other end part of the spool member 601 at a position close to the tip end thereof, thereby allowing adjustment of the clearance from the roll core of the roll paper R_B. The attachment 611B is fixed to the flange 602 in a state where the flange 602 and an end face of the roll paper R_B are in contact with each other, thereby adjusting the clearance from the roll core of the roll paper R_B. The inner diameter of the roll core, which corresponds to the inner diameter of the roll paper R_B, and the outer diameter of the attachments 611B and 612B are approximately equal to each other, and the attachments 611B and 612B are sized to be able to be inserted into the roll core of the roll paper R_B. With this configuration, the attachments 611B and 612B can adjust the clearance between the roll core of the roll paper R_B and the roll holder 620. In addition, each of the attachments 611B and 612B can be removably attached to the roll holder 620.

Note that the attachments 611A and 611B are collectively referred to as an attachment 611. Furthermore, the attachments 612A and 612B are collectively referred to as an attachment 612. Furthermore, having at least any one of the attachments 611A and 612A is sufficient. Similarly, having at least any one of the attachments 611B and 612B is sufficient.

Furthermore, the spool member 601 is driven to rotate in any one of forward and reverse rotational directions by a rotational driving force of the paper feeding motor 201 transmitted to the spool member 601. This operation can drive the roll paper R_A or R_B to rotate. Note that the spool member 601 may be omitted. For example, the attachment 611A may be able to be attached to the central part of the flange 602. With that configuration, the roll paper R can be fixed by the flange 602 with the attachment 611, thereby adjusting the clearance between the roll paper R and the attachment 611. Note that what fixes the attachment 611 to the flange 602 is not limited. For example, the attachment 611 may have a hook and an insertion hole to which the hook can be inserted may be formed in the flange 602 so that the attachment 611 is fixed to the flange 602 by inserting the hook into the insertion hole. Furthermore, if the attachment 612A can be attached to a central part of a member having the same shape as the flange 602, the clearance between the inner diameter of the roll core of the roll paper R and the outer diameter of the attachment 611 can be similarly adjusted.

Furthermore, as shown in FIG. 3, the paper feeding section 200 includes a drive section 3, an arm member 4, an arm rotating shaft 5, a swing member 7, driven rotators 8 and 9, a separation flapper 10 and a flapper rotating shaft 11. The arm member 4 is rotatably provided on the conveying guide 12 via the arm rotating shaft 5. The arm member 4 can rotate about the arm rotating shaft 5 in any of the directions of the arrows A1 and A2. The swing member 7 is provided on a tip end of the arm member 4 in such a manner that the swing member 7 can swing. The driven rotators 8 and 9 are rotatably provided on the swing member 7 at a certain distance from each other along the circumferential direction of the roll paper R. By the arm member 4 rotating in the direction of the arrow A1, the driven rotators 8 and 9 can be pressed against the circumference surface of the roll paper R under a certain pressing force. The separation flapper 10 is provided above the arm member 4 in such a manner that the separation flapper 10 can rotate about the flapper rotating shaft 11 in any of the directions of the arrows B1 and B2. The separation flapper 10 is in contact with and can be lightly pressed against the circumference surface of the roll paper R under its own weight. The sheet 1 passes over the driven rotators 8 and 9 and is drawn from the roll paper R. The drawn sheet 1 is conveyed between the arm member 4 and the separation flapper 10 and thereby fed to the conveying guide 12.

The rotation detecting mechanism 202 is a sensor provided with a rotary encoder physically connected to the paper feeding motor 201. The rotation detecting mechanism 202 operates in association with the spool member 601 as the paper feeding motor 201 drives the spool member 601 to rotate. By this operation, the rotation detecting mechanism 202 detects the rotational angle of the rotational axis of the roll paper R. The circumference detecting mechanism 203 is a sensor provided with a rotary encoder provided in association with the driven rotators 8 and 9. The circumference detecting mechanism 203 rotates along the circumference of the roll paper R at the same time as the roll paper rotates. This rotation allows the circumference detecting mechanism 203 to detect the amount of conveyance of the circumference of the roll paper R. Note that the circumference detecting mechanism 203 is not limited to the sensor provided with a rotary encoder provided in association with the driven rotators 8 and 9. For example, an optical sensor or the like may be used to read reflected light from the circumference of the roll paper R, thereby detecting the amount of rotation of the roll paper R as the amount of conveyance of the circumference of the roll paper R.

Next, details of the conveying section 300 will be described with reference to FIG. 3. The conveying section 300 further includes a conveying roller 14 and a nip roller 15. By looping an endless belt over the conveying roller 14 and the conveying motor 301, the rotational driving force of the conveying motor 301 can be transmitted to the conveying roller 14 via the endless belt. With this configuration, by rotating the conveying motor 301 in the forward or reverse direction, the conveying roller 14 can be rotated in any of the directions of the arrows D1 and D2. The nip roller 15 can be driven to rotate in response to the rotation of the conveying roller 14. The speed of conveyance of the sheet 1 by the conveying roller 14 is set to be higher than the speed of drawing of the sheet 1 by the rotation of the roll paper R. With this setting, a back tension is applied to the sheet 1. Therefore, the sheet 1 can be conveyed in a state where the sheet 1 is tightly stretched. That is, the sheet 1 can be conveyed in a state where a certain tension is applied to the sheet 1.

Next, details of the recording section 400 will be described with reference to FIGS. 2 and 3. The recording head 401 in FIG. 2 ejects ink. By this ejection operation, an image is recorded on the sheet 1. Specifically, the recording head 401 includes an ejection energy generating element and an ejection port. The ejection energy generating element is an electrothermal conversion element or a piezoelectric element, for example. The ink is ejected through the ejection port by the ejection energy generating element. The recording head 401 is provided with a nozzle for each of four color inks, cyan (C), magenta (M), yellow (Y) and black (K). Note that the liquids to be ejected are not limited to the inks described above. For example, a liquid such as white ink as a background color, light color ink, clear ink, metallic ink or a reactant for fixing ink on a recording medium, may be ejected. Furthermore, the recording head 401 is not limited to the inkjet type, and the recording type of the recording section 400 is not also limited. For example, the recording section 400 may be configured to implement the serial scan method. Alternatively, the recording section 400 may be configured to implement the full line method. Furthermore, as shown in FIG. 3, the recording section 400 further includes a platen 17 and a cutter 20. The platen 17 restricts the position of the sheet 1. The cutter 20 cuts the sheet 1 with an image recorded thereon.

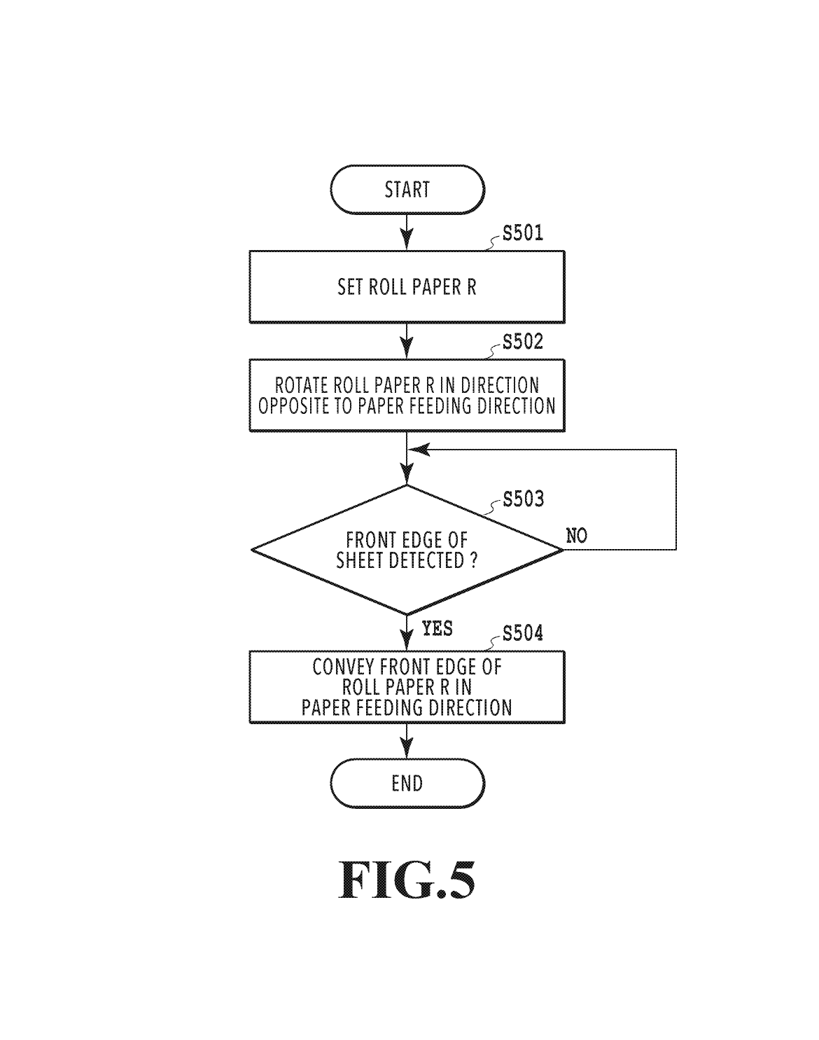

The paper feeding section 200, the conveying section 300 and the recording section 400 described above are controlled by the CPU 102 in FIG. 2. Next, an automatic paper feeding process will be described with reference to FIG. 5. FIG. 5 is a flowchart illustrating an automatic paper feeding process. In the following, details of the automatic paper feeding process will be described with reference to FIG. 5. The process shown in FIG. 5 is implemented by the CPU 102 executing a program deployed in the RAM 104. The process shown in FIG. 5 is performed at a timing when the automatic paper feeding process is started. Note that some or all of the functions in the steps in FIG. 5 may be implemented by hardware, such as an ASIC or an electronic circuit. The character "S" in the description of each processing means a step in the flowchart. Furthermore, the process shown in FIG. 5 may be implemented as a cloud computing arrangement in which one function is distributed among a plurality of resources and served in cooperation over the Internet. For example, the process may be distributed in such a manner that some processing is performed by the recording device 100, and the other processing is performed by the host device. Note that the host device may serve as an information processing apparatus to perform the process shown in the flowchart of FIG. 5.

In S501, the CPU 102 detects that roll paper R is set. The paper feeding section 200 is provided with a sensor (not shown) capable of detecting that roll paper R is set. The sensor can detect that roll paper R is set. The sensor is a photoelectric sensor having a light receiving part and a light emitting part, for example. In the state where no roll paper R is set, the light receiving part and the light emitting part are disposed at positions where the light receiving part can receive light emitted by the light emitting part. In the state where roll paper R is set, the light emitted by the light emitting part is blocked by the roll paper R.

In S502, the CPU 102 makes the sheet 1 of the roll paper R rotate in a direction opposite to the paper feeding direction. In S503, the CPU 102 makes the rotation detecting mechanism 202 determine whether the front edge of the sheet 1 coming off the separation flapper 10 is detected. In a case where the rotation detecting mechanism 202 detects the front edge of the sheet 1, the CPU 102 proceeds from the processing in S503 to the processing in S504. In S504, the CPU 102 causes the front edge of the sheet 1 to be inserted into a sheet supply port between the arm member 4 and the separation flapper 10 and fed to the conveying section 300 via the conveying guide 12. On the other hand, in a case where the rotation detecting mechanism 202 does not detect the front edge of the sheet 1, the CPU 102 continues the processing in S503.

### First Embodiment

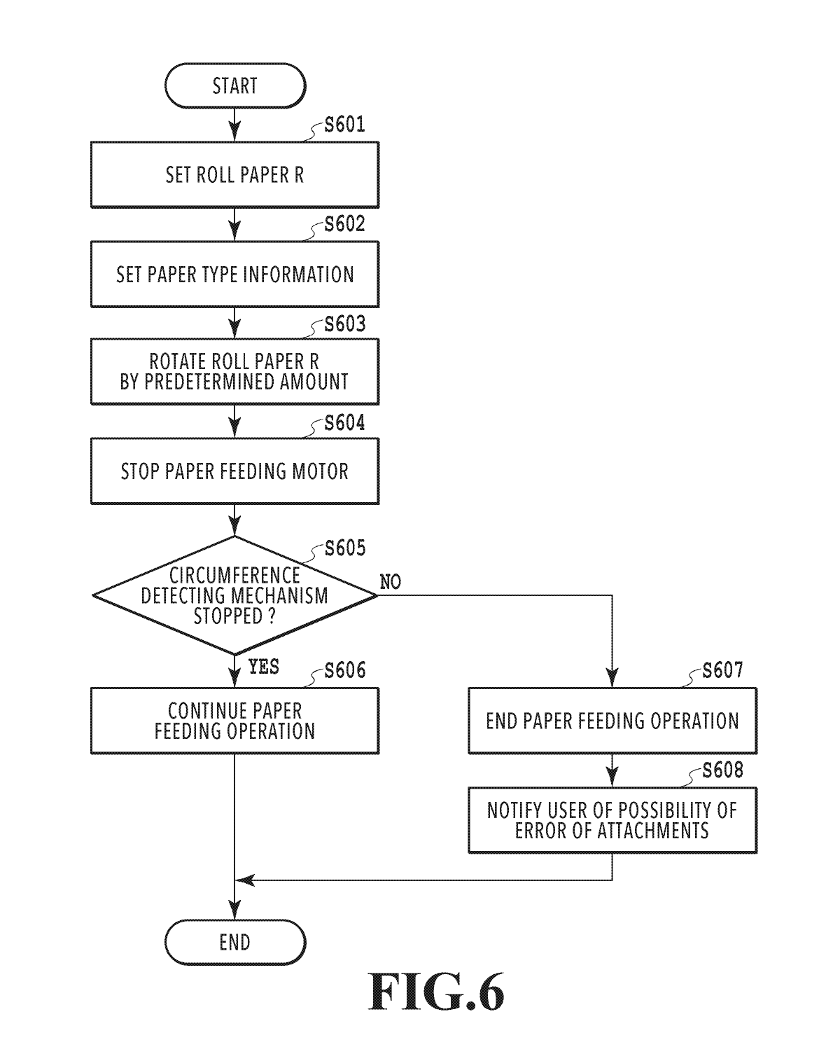

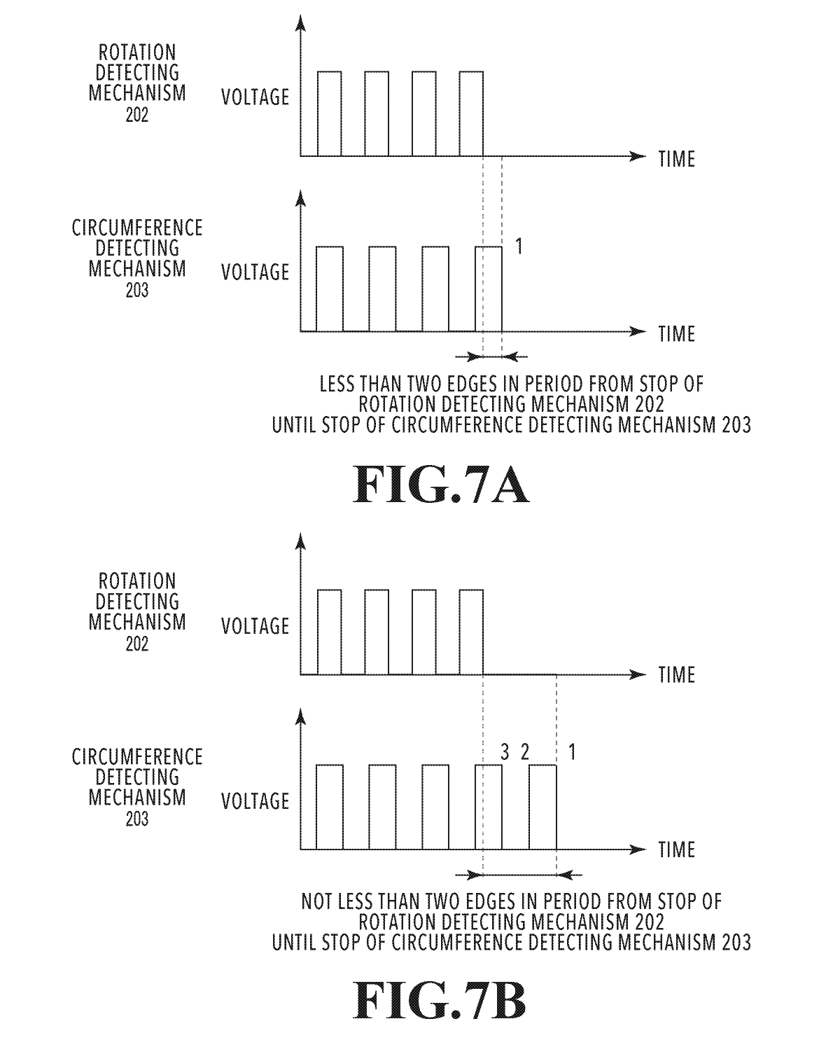

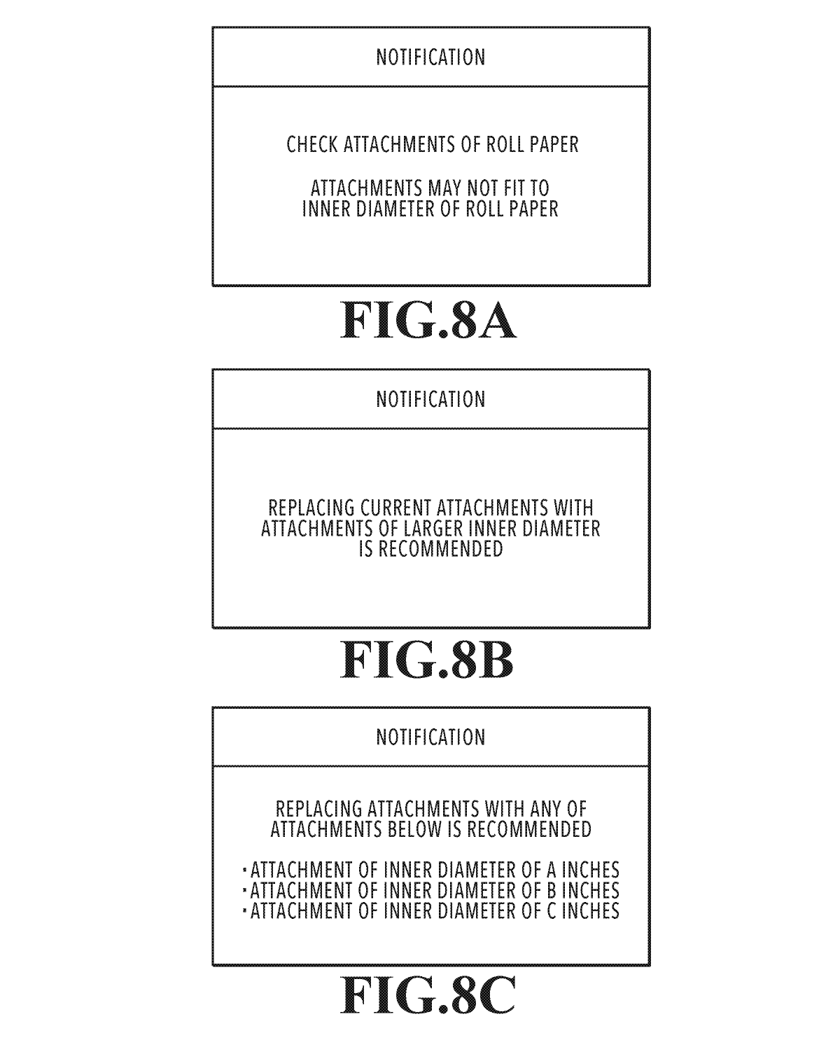

In the following, as a first embodiment, a process of detecting an error of the attachments 611 and 612 will be described with reference to FIGS. 6 to 8A-8C. FIG. 6 is a flowchart illustrating a process of detecting an error of an attachment according to the first embodiment. FIGS. 7A-7B are schematic diagrams showing detected waveforms according to the first embodiment. FIGS. 8A-8C are diagrams showing example displays of notifications according to the first embodiment. In this embodiment, when the rotation detecting mechanism 202 is stopped as the paper feeding motor 201 is stopped, the process described below is performed. That is, the CPU 102 determines by comparison whether the circumference detecting mechanism 203 is stopped at the same time as the rotation detecting mechanism 202, thereby detecting whether the attachments 611 and 612 are properly attached. Here, first to fourth assumptions described below are made. The first assumption is that each of the rotation detecting mechanism 202 and the circumference detecting mechanism 203 is a sensor provided with a rotary encoder. The second assumption is that a rotating state is a state where a change in phase of the sensor using the rotary encoder continues with a predetermined cycle. The third assumption is that a stop state is a time when the change in phase of the sensor using the rotary encoder ends or a state where the state of no change in phase of the sensor using the rotary encoder continues. The fourth assumption is that after the rotation detecting mechanism 202 is determined to be in the stop state, any change in phase of the sensor using the rotary encoder of the circumference detecting mechanism 203 lasts for less than one pulse, that is, the number of rising edges and falling edges of pulses of the rotary encoder is less than 2 in total. When the fourth assumption holds, it is assumed that the rotation detecting mechanism 202 and the circumference detecting mechanism 203 are stopped at the same time.

In the following, details of the process of detecting an error of the attachments will be described with reference to FIG. 6. The process shown in FIG. 6 is implemented by the CPU 102 executing a program deployed in the RAM 104. The process shown in FIG. 6 is performed at a timing when the process of detecting an error of the attachments is started. Note that some or all of the functions in the steps in FIG. 6 may be implemented by hardware, such as an ASIC or an electronic circuit. The character "S" in the description of each processing means a step in the flowchart. Furthermore, the process shown in FIG. 6 may be implemented as a cloud computing arrangement in which one function is distributed among a plurality of resources and served in cooperation over the Internet. For example, the process may be distributed in such a manner that some processing is performed by the recording device 100, and the other processing is performed by the host device. Note that the host device may serve as an information processing apparatus to perform the process shown in the flowchart of FIG. 6.

In case where the process from S601 to S606 in FIG. 6 is performed, an operation from the start of automatic paper feeding of the sheet 1 to the end of the automatic paper feeding is performed. In the meanwhile, the process from S601 to S605 and then to S607 and S608 is performed, an operation is performed as follows. That is, an operation of detecting that wrong attachments 611 and 612 that do not fit to the inner diameter of the roll core of the roll paper R is used from the start of automatic paper feeding of the sheet 1, ending the automatic paper feeding and making a notification to the user.

In S601, the CPU 102 detects that roll paper R is set. In S602, the CPU 102 sets paper type information on the roll paper R based on an instruction from the user. Note that the instruction from the user is received in response to the user operating the operation panel 106, for example. Alternatively, the instruction from the user may be received via the recording device driver 107, for example. In S603, the CPU 102 causes the roll paper R to be rotated by a predetermined amount. In S604, the CPU 102 causes the paper feeding motor 201 to stop. By this stop operation, the rotation detecting mechanism 202 is also stopped. Then, by determining whether the circumference detecting mechanism 203 is stopped at the same time, whether the attachments 611 and 612 are properly attached can be detected. That is, if the outer diameter of the attachments 611 and 612 is substantially smaller than the inner diameter of the roll core of the roll paper R, the circumference detecting mechanism 203 does not follow the movement of the rotation detecting mechanism 202. Therefore, by detecting whether the movement of the circumference detecting mechanism 203 is following the movement of the rotation detecting mechanism 202, whether the attachments 611 and 612 are properly attached can be detected.

In S605, the CPU 102 determines whether the circumference detecting mechanism 203 is stopped. In a case where it is determined that the circumference detecting mechanism 203 is stopped, the CPU 102 proceeds from the processing in S605 to the processing in S606. In S606, the CPU 102 continues the paper feeding operation. On the other hand, in a case where it is determined that the circumference detecting mechanism 203 is not stopped, the CPU 102 proceeds from the processing in S605 to the processing in S607. In S607, the CPU 102 ends the paper feeding operation. Here, detected waveforms of the circumference detecting mechanism 203 will be described with reference to FIGS. 7A-7B. FIG. 7A shows a case where the number of edges of the detected waveform required until the circumference detecting mechanism 203 is stopped after the rotation detecting mechanism 202 is stopped is less than two. As shown in FIG. 7A, when the number of edges of the detected waveform required until the circumference detecting mechanism 203 is stopped is less than two, it is determined that the roll paper R is stopped as the paper feeding motor 201 is stopped. Therefore, the attachments 611 and 612 are determined to be properly attached, and the paper feeding operation can be continued. On the other hand, FIG. 7B shows a case where the number of edges of the detected waveform required until the circumference detecting mechanism 203 is stopped after the rotation detecting mechanism 202 is stopped is not less than two. As shown in FIG. 7B, in a case where the number of edges of the detected waveform required until the circumference detecting mechanism 203 is stopped is not less than two, it is determined that the roll paper R is not stopped as the paper feeding motor 201 is stopped. Therefore, the attachments 611 and 612 are not determined to be properly attached, and the paper feeding operation is ended.

Here, a reason why the number of edges of the detected waveform should be noted will be described. The roll paper R is fixed by the attachments 611 and 612. Therefore, the rotation detecting mechanism 202 and the circumference detecting mechanism 203 rotate in a one-to-one correspondence. Therefore, without external factors, no misalignment occurs between the detected waveform of the rotation detecting mechanism 202 and the detected waveform of the circumference detecting mechanism 203. The external factors include misalignment due to vibrations, for example. Taking misalignment due to vibrations into account, the example detected waveforms in FIG. 7A has a tolerance for a difference of up to one pulse, that is, up to two edges. In this way, a tolerance for the difference in number of edges is desirably provided. Such a tolerance is determined by considering the rotary encoder used in each of the rotation detecting mechanism 202 and the circumference detecting mechanism 203 or the paper holding power of the attachments 611 and 612, for example.

In S608, the CPU 102 notifies the user of the possibility that wrong attachments 611 and 612 that do not fit to the inner diameter of the roll core of the roll paper R are used, and ends the process. The destination of the notification is the operation panel 106, for example. Details of such notifications will be described with reference to FIGS. 8A-8C.

FIG. 8A is a diagram showing an example in which the possibility that the attachments 611 and 612 have wrong sizes is indicated. In the example in FIG. 8A, "CHECK ATTACHMENTS OF ROLL PAPER" is first displayed. In the example in FIG. 8A, second, "ATTACHMENTS MAY NOT FIT TO INNER DIAMETER OF ROLL PAPER" is displayed. That is, as information relating to the attachments, the possibility that the attachments 611 and 612 do not fit to the inner diameter of the roll core of the roll of recording medium is notified.

Notifications to the user are not limited to the notification in FIG. 8A. FIG. 8B is a diagram showing an example in which replacing the attachments 611 and 612 with other attachments is recommended. In the example in FIG. 8B, "REPLACING CURRENT ATTACHMENTS WITH ATTACHMENTS WITH LARGER INNER DIAMETER IS RECOMMENDED" is displayed. That is, as information relating to the attachments, a notification is made that recommends replacing the attachments with larger attachments. FIG. 8C is a diagram showing another example in which replacing the attachments 611 and 612 with other attachments is recommended. In the example in FIG. 8C, "REPLACING ATTACHMENTS WITH ANY OF ATTACHMENTS BELOW IS RECOMMENDED" is first displayed. In the example in FIG. 8C, second, "ATTACHMENT OF INNER DIAMETER OF A INCHES" is displayed. Furthermore, in the example in FIG. 8C, third, "ATTACHMENT OF INNER DIAMETER OF B INCHES" is displayed. Furthermore, in the example in FIG. 8C, fourth, "ATTACHMENT OF INNER DIAMETER OF C INCHES" is displayed. That is, as information relating to the attachments, it may be notified that replacing the attachments with possible replacements of a suitable size is recommended

As described above, according to this embodiment, the roll holder 620 fixes a roll of recording medium, such as roll paper R. The attachments 611 and 612 are removably attached to the roll holder 620. The attachments 611 and 612 can adjust the clearance between the roll core of the roll paper R and the roll holder 620. The paper feeding motor 201 rotates the roll paper R with the roll holder 620. The rotation detecting mechanism 202 detects the rotational angle of the rotational axis of the roll paper R. The circumference detecting mechanism 203 detects the amount of conveyance of the circumference of the roll paper R. Based on the detection results from the rotation detecting mechanism 202 and the circumference detecting mechanism 203, information relating to the attachments 611 and 612 are notified. With such a configuration, whether the attachments do not fit to the roll core of the roll paper R can be notified, so that a difficulty in continuing paper feeding or occurrence of a jam can be prevented.

Furthermore, according to this embodiment, as information relating to the attachments 611 and 612, the possibility that the attachments 611 and 612 have a size that does not fit to the inner diameter of the roll core of the roll paper R may be notified. With such a configuration, the user can be notified of whether the attachments 611 and 612 have a proper size.

Furthermore, according to this embodiment, as information relating to the attachments 611 and 612, it may be notified that replacing the attachments 611 and 612 with attachments of a larger size is recommended. With such a configuration, the user can be notified of a specific size of the replacements for the attachments 611 and 612.

Furthermore, according to this embodiment, the shape of the attachments 611 and 612 is a cylindrical shape. As the size of the attachments 611 and 612, the outer diameter of the attachments 611 and 612 may be notified. With such a configuration, the user can be notified of a more specific size of the replacements for the attachments 611 and 612.

Furthermore, according to this embodiment, as information relating to the attachments 611 and 612, it may be notified that replacing the attachments 611 and 612 with possible replacements of a suitable size is recommended. With such a configuration, the user can be notified of possible replacements for the attachments 611 and 612.

Furthermore, according to this embodiment, the shape of the attachments 611 and 612 is a cylindrical shape. Furthermore, as possible replacements of suitable sizes for the attachments 611 and 612, multiple options of different outer diameters of attachments may be notified. With such a configuration, the user can be notified of options for replacement for the attachments 611 and 612.

Furthermore, according to this embodiment, information relating to the attachments 611 and 612 may be notified as a notification image. With such a configuration, the user can be notified in the form of an image.

Furthermore, according to this embodiment, when information relating to the attachments 611 and 612 is notified as a notification image, the notification image may be displayed as an image. With such a configuration, the notification image can be displayed, so that the user can immediately understand the notification.

Furthermore, according to this embodiment, in a case where information relating to the attachments 611 and 612 is notified as a notification image, a summary of the notification image may be displayed in a manner of banner on a part of the image on the smartphone of the user. With such a configuration, a notification contents can be notified in a manner of banner on the smartphone of the user.

Furthermore, according to this embodiment, in case of notifying information relating to the attachments 611 and 612, a vibrator of the smartphone of the user may be made to vibrate. With such a configuration, since the vibrator can be made to vibrate, a vibration function of the smartphone of the user can be activated.

Furthermore, according to this embodiment, in case of notifying information relating to the attachments 611 and 612, the information relating to the attachments 611 and 612 may be output as audio through the speaker of the smartphone of the user. With such a configuration, since audio can be output, an audio output function of the smartphone of the user can be activated.

Furthermore, according to this embodiment, information relating to the attachments 611 and 612 may be transmitted by e-mail from a transmitter capable of transmitting e-mails. With such a configuration, a notification can be made by e-mail.

Furthermore, according to this embodiment, in a case where it is determined that the attachments do not fit to the roll paper R based on the detection result from the rotation detecting mechanism 202 and the detection result from the circumference detecting mechanism 203, information relating to the attachments may be notified. With such a configuration, information relating to the attachments that do not fit to the roll paper R can be notified.

Furthermore, according to this embodiment, in case where the rotation detecting mechanism 202 does not rotate and the circumference detecting mechanizum 203 rotates when the paper feeding motor 201 stops rotating after the paper feeding motor 201 rotates, it may be determined that the attachments 611, 612 do not fit to the roll paper R. With such a configuration, it is detected that the amount of conveyance of the circumference of the roll paper R disagrees with the amount of change of the rotational angle of the roll paper R, so that it can be detected with reliability that the attachments 611 and 612 do not fit to the roll paper R.

### Second Embodiment

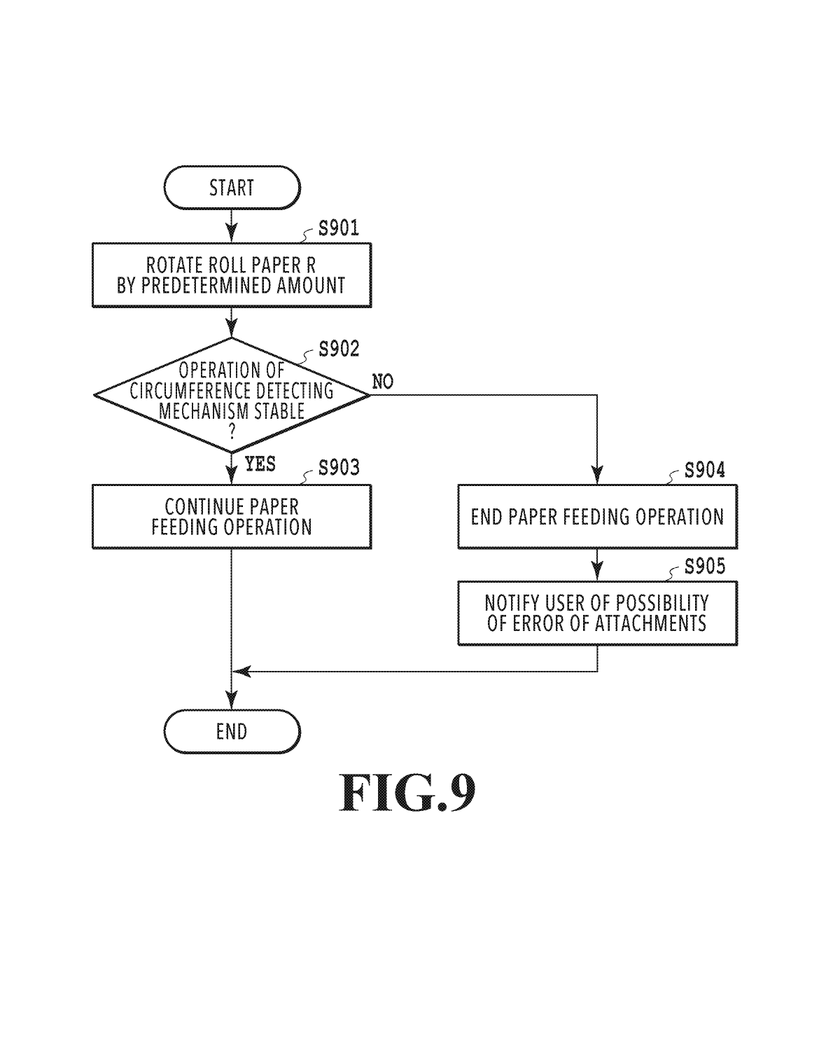

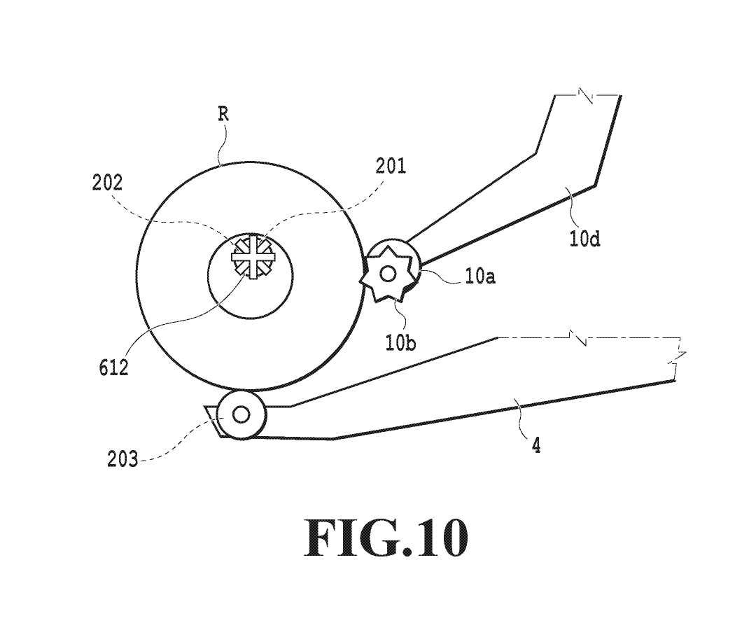

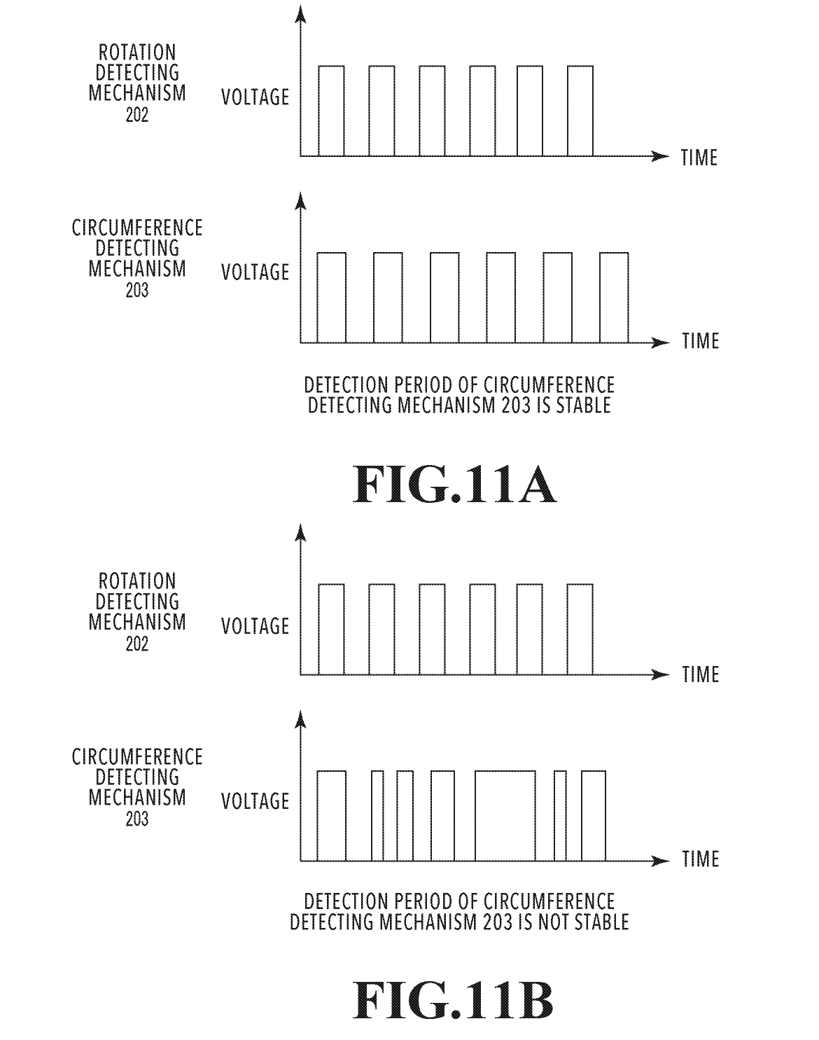

A second embodiment differs from the first embodiment in that an error of the attachments is detected by determining whether the rotational operation period of the circumference detecting mechanism 203 is stable during a predetermined amount of rotation of the roll paper R. In the following, this embodiment will be described with reference to FIGS. 9 to 11A-11B. FIG. 9 is a flowchart illustrating a process of detecting an error of the attachments. FIG. 10 is a schematic diagram showing essential parts in the second embodiment. FIGS. 11A-11B are schematic diagrams showing detected waveforms in the second embodiment.

Note that it is assumed that a stable state is a state where a change in phase of the encoder sensor of the circumference detecting mechanism 203 continuously occurs at a predetermined period. In addition, it is assumed that an unstable state is a state where a change in phase of the encoder sensor of the circumference detecting mechanism 203 discontinuously occurs or does not occur at a predetermined period.

Specifically, the CPU 102 compares a maximum pulse period and a minimum pulse period of the detected pulses of the circumference detecting mechanism 203 in a period from the start of rotation of the paper feeding motor 201 until the number of pulses of the rotation detecting mechanism 202 reaches 20000 in operation. When the maximum pulse period is twice as long as the minimum pulse period, it is determined that the roll paper R does not rotate in association with the operation of the paper feeding motor 201 and that the state is the unstable state. The pulse referred to herein is the detected waveform described later with reference to FIGS. 11A-11B.

Note that in the period from the start of rotation of the paper feeding motor 201 until the number of pulses of the rotation detecting mechanism 202 reaches 20000 in operation, the first five pulses of the circumference detecting mechanism 203 are ignored to allow for a period of stabilization of operation. When any pulses including the first five pulses as a margin described above are not detected from the circumference detecting mechanism 203, it is also determined that the roll paper R does not rotate in association with the operation of the paper feeding motor 201 and that the state is the unstable state.

Although the determination described above is made in this embodiment as to whether the attachments are properly attached, the determination method is not limited to the method described above, and any other determination method can be used as far as the determination is made based on comparison between the operating state of the paper feeding motor 201 and the rotational state of the circumference detecting mechanism 203.

In the following, details of the process of detecting an error of the attachments will be described with reference to FIG. 9. The process shown in FIG. 9 is implemented by the CPU 102 executing a program deployed in the RAM 104. The process shown in FIG. 9 is performed at a timing when the process of detecting an error of the attachments is started. Note that some or all of the functions in the steps in FIG. 9 may be implemented by hardware, such as an ASIC or an electronic circuit. The character "S" in the description of each processing means a step in the flowchart. Furthermore, the process shown in FIG. 9 may be implemented as a cloud computing arrangement in which one function is distributed among a plurality of resources and served in cooperation via the Internet. For example, the process may be distributed in such a manner that some processing is performed by the recording device 100, and the other processing is performed by the host device. Note that the host device may serve as an information processing apparatus to perform the process shown in the flowchart of FIG. 9.

In S901, the CPU 102 causes a predetermined amount of rotation of the roll paper R. In S902, the CPU 102 determines whether the operation of the circumference detecting mechanism 203 is stable during rotation of the paper feeding motor 201. In case where it is determined that the operation of the circumference detecting mechanism 203 is stable during rotation of the paper feeding motor 201, the CPU 102 proceeds from the processing in S902 to the processing in S903. In S903, the CPU 102 continues the paper feeding operation. On the other hand, in case where it is determined that the operation of the circumference detecting mechanism 203 is not stable during rotation of the paper feeding motor 201, the CPU 102 proceeds from the processing in S902 to the processing in S904. In S904, the CPU 102 ends the paper feeding operation.

Here, a state where the attachment 612 does not fit to the roll paper R will be described with reference to FIG. 10. The separation flapper 10 includes a driven roller 10a, a separation part 10b and a supporting member 10d. The driven roller 10a is rotatably supported by the supporting member 10d. The separation part 10b is supported by the supporting member 10d and separates the front edge of the sheet 1 from the roll paper R. As shown in FIG. 10, the outer diameter of the attachment 612 is substantially smaller than the inner diameter of the roll core of the roll paper R, so that the rotational axis of the rotation detecting mechanism 202 and the rotational axis of the roll paper R substantially disagree. Therefore, the rotation speed of the circumference detecting mechanism 203 is unstable, and the detection period of the circumference detecting mechanism 203 is also unstable.

Next, detected waveforms from the circumference detecting mechanism 203 will be described with reference to FIGS. 11A-11B. FIG. 11A shows a case where the detection period of the circumference detecting mechanism 203 is stable during rotation of the rotation detecting mechanism 202. FIG. 11B shows a case where the detection period of the circumference detecting mechanism 203 is not unstable during rotation of the rotation detecting mechanism 202. As shown in FIG. 11A, in case where the detection period of the circumference detecting mechanism 203 is stable, it can be determined that the roll paper R is rotating in association with the operation of the paper feeding motor 201. Therefore, it can be determined that the attachments are properly attached, and the paper feeding operation can be continued. On the other hand, as shown in FIG. 11B, in case where the detection period of the circumference detecting mechanism 203 is unstable, it can be determined that the roll paper R is not operating in association with the operation of the paper feeding motor 201. Therefore, it is determined that the roll paper R is attached with wrong attachments, and an operation of ending the paper feeding operation is performed.

Referring back to FIG. 9, in S905, the CPU 102 notifies the user of the possibility that wrong attachments 611 and 612 that do not fit to the inner diameter of the roll core of the roll paper R are used, and ends the process. The destination of the notification is the operation panel 106, for example. A detailed notification is the notification shown in FIG. 8A described above in the first embodiment, for example.

Note that for the detection period of the circumference detecting mechanism 203 in this embodiment, a threshold suitable for the configuration of the recording device 100 is provided to allow for the displacement of the circumference in one rotation of the roll paper R. The number of pulses of 20000 described above is a value determined assuming the maximum looseness of the roll paper R at the start of movement. In addition, it is assumed that the maximum pulse period is not more than twice as long as the minimum pulse period even when there is no looseness, and the attachments 611 and 612 are properly attached. A reason for this is that a certain pressing force is applied to the circumferential surface of the roll paper R by the swing member 7 provided with the driven rotator 9 including the circumference detecting mechanism 203.

As described above, according to this embodiment, when the detection period of the circumference detecting mechanism 203 is not stable during rotation of the paper feeding motor 201, it may be determined that the attachments 611 and 612 do not fit to the roll paper R. With such a configuration, a misalignment of the circumference detecting mechanism 203 during rotation of the paper feeding motor 201 can be detected.

### Third Embodiment

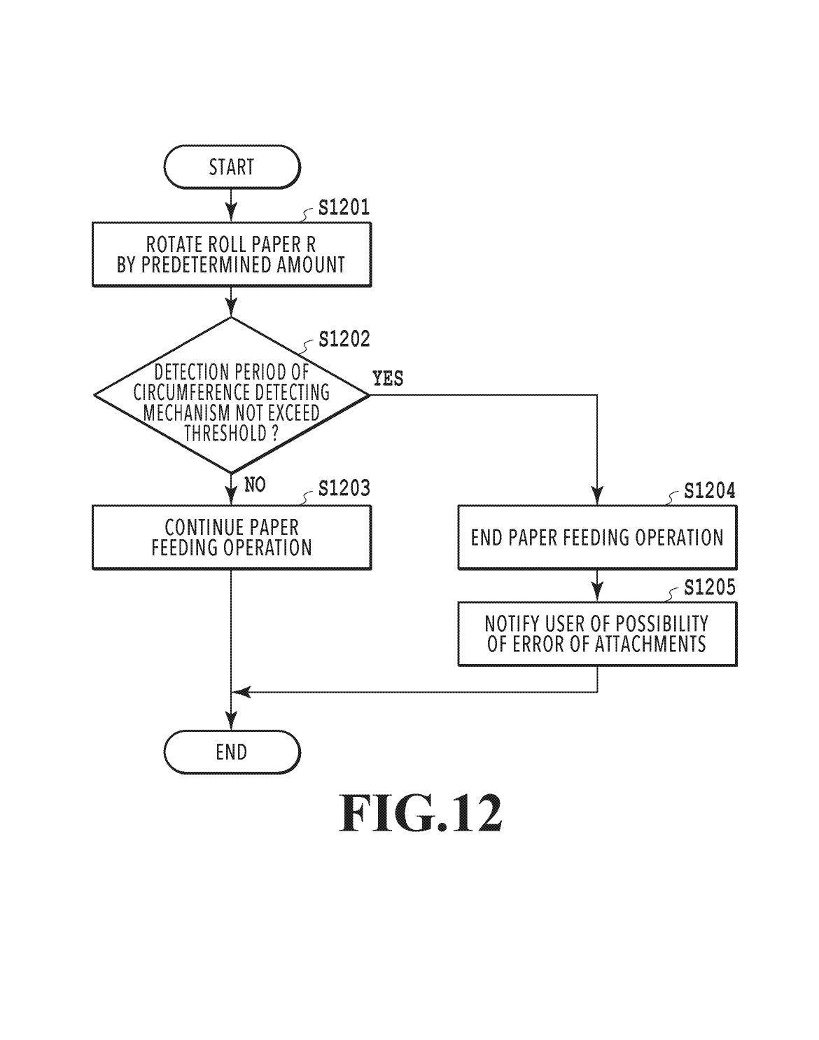

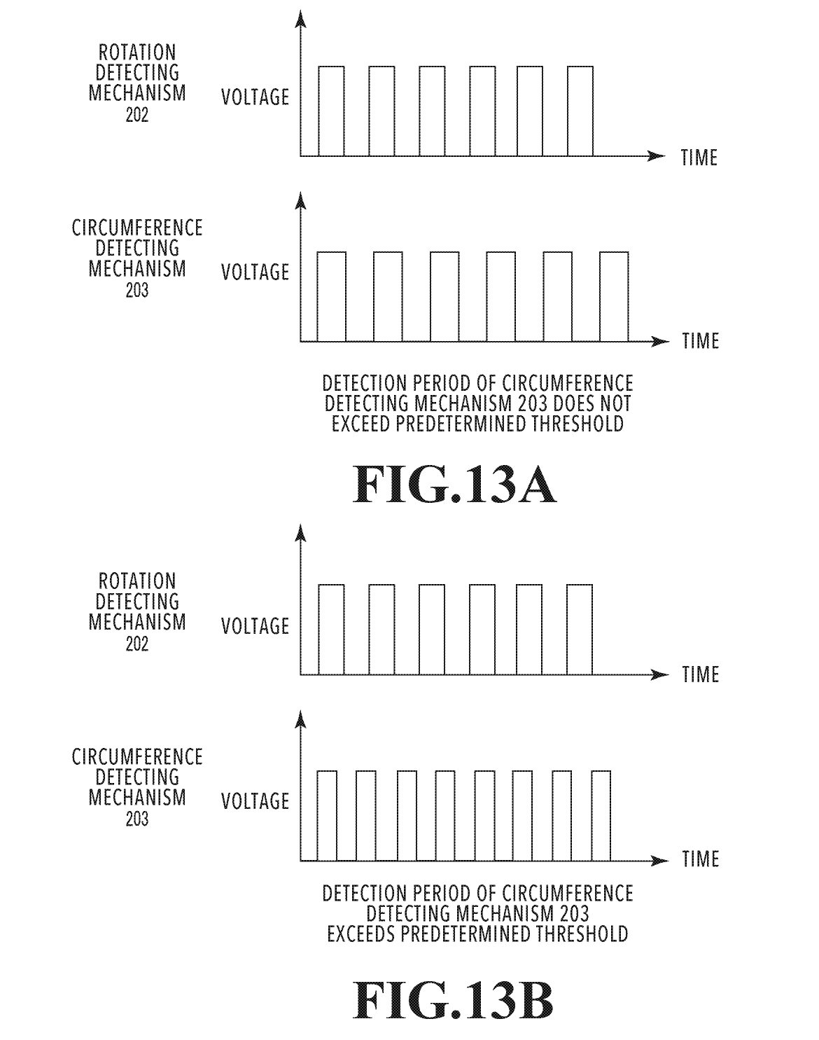

A third embodiment differs from the first and second embodiments in that an error of the attachments is detected by determining whether the rotational operation period of the circumference detecting mechanism 203 does not exceed a predetermined threshold. In the following, this embodiment will be described with reference to FIGS. 12 and 13A-13B. FIG. 12 is a flowchart illustrating a process of detecting an error of the attachments according to the third embodiment. FIGS. 13A-13B are schematic diagrams showing detected waveforms in the third embodiment.

Specifically, when roll paper R having an inner diameter of 3 inches and an outer diameter r1 of 170 mm is set in the recording device 100 having an outer diameter limit of roll paper R of 170 mm, the detection pulse period of the circumference detecting mechanism 203 is 125 ms in the state where right attachments are attached. In case where the same roll paper R is set in the recording device 100 described above, in the state where wrong attachments for an inner diameter of 2 inches are attached, the apparent outer diameter is 190 mm, and the detection pulse period of the circumference detecting mechanism 203 is 112.5 ms, which is 1/1.12 or 0.89 times longer than in the state where right attachments are attached. Note that the value of 112.5 ms described above is the largest possible threshold, and an optimum threshold can be set if the recording device 100 is configured so that the remaining amount or outer diameter of the roll paper R can be input or measured at the time of setting.

When the detection pulse period of the circumference detecting mechanism 203 is less than 112.5 ms in a period from the start of rotation of the paper feeding motor 201 until the number of pulses of the rotation detecting mechanism 202 reaches 20000, the CPU 102 determines that the attachments are not properly attached.

In the following, details of the process of detecting an error of the attachments will be described with reference to FIG. 12. The process shown in FIG. 12 is implemented by the CPU 102 executing a program deployed in the RAM 104. The process shown in FIG. 12 is performed at a timing when the process of detecting an error of the attachments is started. Note that some or all of the functions in the steps in FIG. 12 may be implemented by hardware, such as an ASIC or an electronic circuit. The character "S" in the description of each processing means a step in the flowchart. Furthermore, the process shown in FIG. 12 may be implemented as a cloud computing arrangement in which one function is distributed among a plurality of resources and served in cooperation via the Internet. For example, the process may be distributed in such a manner that some processing is performed by the recording device 100, and the other processing is performed by the host device. Note that the host device may serve as an information processing apparatus to perform the process shown in the flowchart of FIG. 12.

In S1201, the CPU 102 causes a predetermined amount of rotation of the roll paper R. In S1202, when it is determined that the detection period of the circumference detecting mechanism 203 does not exceed a predetermined threshold, the CPU 102 proceeds from the processing in S1202 to the processing in S1203. In S1203, the CPU 102 continues the paper feeding operation. On the other hand, when it is determined that the detection period of the circumference detecting mechanism 203 exceeds the predetermined threshold, the CPU 102 proceeds from the processing in S1202 to the processing in S1204. In S1204, the CPU 102 ends the paper feeding operation. In S1205, the CPU 102 notifies the user of the possibility that wrong attachments 611 and 612 that do not fit to the inner diameter of the roll core of the roll paper R are used, and ends the process. The destination of the notification is the operation panel 106, for example. A detailed notification is the notification shown in FIG. 8A described above in the first embodiment, for example.

As described above, according to this embodiment, when the detection period of the circumference detecting mechanism 203 exceeds a predetermined threshold during rotation of the paper feeding motor 201, it may be determined that the attachments 611 and 612 do not fit to the roll paper R. With such a configuration, a misalignment of the circumference detecting mechanism 203 during rotation of the paper feeding motor 201 can be detected.

### Combinations of First to Third Embodiments

Next, processes of determining whether the attachments 611 and 612 are properly attached in the following use cases (i) to (iii) will be described. In this embodiment, the rotation of the rotational axis of the roll paper R and the rotation of the circumference of the roll paper R are compared. Thus, it is determined that there is an anomaly of the attachments when the amount of rotation of the circumference of the roll paper R does not correspond to the amount of rotation of the rotational axis of the roll paper R. Alternatively, it is estimated that there is a failure in any of the rotation detecting mechanism 202 and the circumference detecting mechanism 203 when the amount of rotation of the circumference of the roll paper R does not corresponds to the amount of rotation of the rotational axis of the roll paper R. Therefore, whether genuine or not, any attachment that can properly transfer the rotation of the rotational axis of the roll paper R to the roll paper R can be used.

### Use Case (i)

As a use case (i), attachments for another model produced by the same manufacturer are assumed. For example, the use case (i) is as follows. That is, the attachments for the other machine can be used as replacements for the current machine if the current machine conforms to the standard of the other machine. On the other hand, the attachments for the other machine cannot be used as replacements for the current machine if the current machine does not conform to the standard of the other machine, since the attachments cannot be attached.

### Use Case (ii)

As a use case (ii), attachments produced by a different manufacturer that fit to roll paper R whose inner diameter of the roll core is 2 inches or 3 inches are assumed. For example, the attachments produced by the different manufacturer can be used as replacements for the current machine if the attachments can properly transfer the rotation of the rotational axis of the roll paper R to the roll paper R. On the other hand, the attachments produced by the different manufacturer cannot be used as replacements for the current machine if the attachments cannot properly transfer the rotation of the rotational axis of the roll paper R to the roll paper R. Specifically, when the detected waveforms are the waveforms in the second embodiment shown in FIG. 11A or the waveforms in the third embodiment shown in FIG. 13A, the attachments can properly transfer the rotation of the rotational axis of the roll paper R to the roll paper R and therefore can be used. On the other hand, when the detected waveforms are the waveforms in the second embodiment shown in FIG. 11B or the waveforms in the third embodiment shown in FIG. 13B, the attachments cannot properly transfer the rotation of the rotational axis of the roll paper R to the roll paper R and therefore cannot be used.

### Use Case (iii)

As a use case (iii), attachments of the same model and size produced by the same manufacturer are assumed. For example, even attachments of the same model and size produced by the same manufacturer cannot be used if the attachments insufficiently transfer the rotation to the roll paper R because of aging. Whether the transfer of the rotation to the roll paper R is insufficient can be determined by monitoring the extent to which the detected waveform from the circumference detecting mechanism 203 follows the detected waveform from the rotation detecting mechanism 202.

### Other Embodiments

Although various examples and embodiments of the present disclosure have been described above, the spirit and scope of the present disclosure are not limited to the specific description in this specification. The present disclosure is not limited to the embodiments described above, and various modifications can be made. Furthermore, parts of the embodiments of the present disclosure described above can be combined as required.

### Variation 1

For example, although examples in which information relating to the attachments 611 and 612 is notified through screen display have been described in the first to third embodiments, this is not particularly intended to be limiting. For example, information relating to the attachments 611 and 612 may be notified by the audio output function of the smartphone of the user. Alternatively, information relating to the attachments 611 and 612 may be notified by the banner notification function of the smartphone of the user. In the latter case, a summary of the information relating to the attachments 611 and 612 may be displayed as a banner. Alternatively, when information relating to the attachments 611 and 612 is notified, the vibration function of the smartphone of the user may be activated at the same time. Alternatively, information relating to the attachments 611 and 612 may be notified by e-mail. In the latter case, a transmitter capable of transmitting e-mails to a mail server can be provided, an e-mail address of a notification target, such as the user, can be set as the destination. Any of these functions can notify whether the attachments do not fit to the inner diameter of the roll core of the roll paper R, and therefore, the roll paper R can be prevented from continuing rotating improperly. Therefore, a state where paper cannot be fed or occurrence of a jam can be prevented.

### Variation 2

Although examples in which the rotational angle of the rotation axis of the roll paper R is detected by the rotation detecting mechanism 202 have been described in the first to third embodiments, this is not particularly intended to be limiting. The rotation detecting mechanism 202 rotates as the paper feeding motor 201 rotates, and the detected waveform as the detection result of the rotation detecting mechanism 202 is a reference waveform for comparison with the detected waveform as the detection result of the circumference detecting mechanism 203. Therefore, for example, the rotational angle of the rotational axis of the roll paper R may be stored in advance in the ROM 103 or the storage section 105, and the CPU 102 may obtain the stored rotational angle of the rotational axis of the roll paper R as required. In other words, information relating to the attachments 611 and 612 may be notified based on the obtained result of the stored rotational angle of the rotational axis of the roll paper R and the detection result from the circumference detecting mechanism 203.

### Variation 3

Although examples in which the shape of the attachments 611 and 612 is a cylindrical shape have been described in the first to third embodiments, this is not particularly intended to be limiting. The attachments can have any shape that allows the attachments to be in contact with the inside of the roll core of the roll paper R under an appropriate frictional force and to transfer the rotational driving force of the paper feeding motor 201 to the roll paper R without a time lag. For example, the attachments 611 and 612 may have a polygonal shape. Alternatively, the attachments 611 and 612 may be shaped with a plurality of protrusions each of which is provided with a non-slip member made of rubber or the like at the tip end thereof.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, a state where paper cannot be fed or occurrence of a jam can be prevented.

This application claims the benefit of Japanese Patent Application No. 2025-002172, filed January 7, 2025 which is hereby incorporated by reference herein in its entirety.

What is claimed is:

1. A paper feeding device, comprising:
a roll holder configured to fix a roll of recording medium;
an attachment configured to be removably attached to the roll holder and capable of adjusting a clearance between a roll core of the roll of recording medium and the roll holder;
a motor configured to rotate the roll of recording medium with the roll holder;
a rotation obtaining unit configured to obtain a rotational angle of a rotational axis of the roll recording medium;
a circumference detection unit configured to detect an amount of conveyance of a circumference of the roll of recording medium; and
a notification unit configured to notify information relating to the attachment based on an obtaining result from the rotation obtaining unit and based on a detection result from the circumference detection unit.

2. The paper feeding device according to claim 1, wherein as the information relating to the attachment, the notification unit notifies a possibility that a size of the attachment does not fit to an inner diameter of the roll core of the roll of recording medium.

3. The paper feeding device according to claim 1, wherein as the information relating to the attachment, the notification unit notifies a recommendation that the attachment is replaced with another attachment whose size is larger than the size of the attachment.

4. The paper feeding device according to claim 3, wherein a shape of the attachment is a cylindrical shape, and
the notification unit notifies an outer diameter of the attachment as the size of the attachment.

5. The paper feeding device according to claim 1, wherein as the information relating to the attachment, the notification unit notifies a recommendation that the attachment is changed with another attachment which is selectable size as a substitution of the attachment.

6. The paper feeding device according to claim 5, wherein a shape of the attachment is a cylindrical shape, and
the notification unit notifies multiple options of outer diameters of the attachments as the substitution of the attachment.

7. The paper feeding device according to claim 1, wherein the notification unit notifies the information relating the attachment as a notification image.

8. The paper feeding device according to claim 7, wherein in case where the notification unit notifies the information relating the attachment as a notification image, the notification unit has the notification image to be displayed.

9. The paper feeding device according to claim 7, wherein in case where the notification unit notifies the information relating the attachment as a notification image, the notification unit has a summary of the notification image to be displayed in a manner of banner on a smartphone of a user.

10. The paper feeding device according to claim 1, wherein in case where the notification unit notifies the information relating the attachment, the notification unit has a vibrator of a smartphone of a user to vibrate.

11. The paper feeding device according to claim 1, wherein in case where the notification unit notifies the information relating the attachment, the notification unit has the information relating to the attachment to output as audio through a speaker of a smartphone of a user.

12. The paper feeding device according to claim 1, further comprising a transmitter capable of transmitting an e-mail,
wherein the notification unit has the transmitter to transmit the information relating to the attachment by the e-mail.

13. The paper feeding device according to claim 1, further comprising a control unit configure to notify the information relating to the attachment in a case of the attachment being determined not to fit to the roll of recording medium based on the obtaining result from the rotation obtaining unit and based on the detection result from the circumference result from the circumference detection unit.

14. The paper feeding device according to claim 13, further comprising a rotation detecting unit configured to detect the rotational angle of the rotational axis of the roll of recording medium,
wherein the rotation detecting unit detects the rotational angle of the rotational axis of the roll of recording medium through rotation of the rotation detecting unit,
the circumference detection unit detects the rotational angle of the rotational axis of the roll of recording medium through rotation of the circumference detection unit, and
the control unit determines that the attachment does not fit to the roll of recording medium in case where the rotation detecting unit does not rotate and the circumference detection unit rotates when the motor stops rotating after the motor rotates.

15. The paper feeding device according to claim 13, wherein the circumference detection unit detects the rotational angle of the rotational axis of the roll of recording medium through rotation of the circumference detection unit, and
the control unit determines that the attachment does not fit to the roll of recording medium in case where a detection period of the circumference detection unit is not stable during rotation of the motor.

16. The paper feeding device according to claim 13, wherein the circumference detection unit detects the rotational angle of the rotational axis of the roll of recording medium through rotation of the circumference detection unit, and
the control unit determines that the attachment does not fit to the roll of recording medium in case where a detection period of the circumference detection unit exceeds a predetermined threshold during rotation of the motor.

17. A paper feeding method, comprising:
obtaining a rotational angle of a rotational axis of a roll of recording medium;
detecting an amount of conveyance of a circumference of the roll of recording medium; and
notifying information relating to an attachment based on the rotational angle and the amount of conveyance of the circumference, the attachment being removably attached to a roll holder and being capable of adjusting a clearance between a roll core of the roll of recording medium and the roll holder, the roll holder fixing the roll of recording medium.

18. A computer-readable recording medium comprising instructions, which when implemented by one or more computers that cause the one or more computers to perform the following operations:
obtaining a rotational angle of a rotational axis of a roll of recording medium;
detecting an amount of conveyance of a circumference of the roll of recording medium; and
notifying information relating to an attachment based on the rotational angle and the amount of conveyance of the circumference, the attachment being removably attached to a roll holder and being capable of adjusting a clearance between a roll core of the roll of recording medium and the roll holder, the roll holder fixing the roll of recording medium.
